(19) United States
(12) Patent Application Publication
(10) Pub. No.: US 2010/0037878 A1
(43) Pub. Date: Feb. 18, 2010

(54) Methods and Apparatus for a Projectile Firing System

(76) Inventor: Kurt Leinbach, Mesa, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/543,425

(22) Filed: Aug. 18, 2009

Related U.S. Application Data
(60) Provisional application No. 61/089,693, filed on Aug. 18, 2008.

(51) Int. Cl. F41B 7/00; B23P 11/00

(52) U.S. Cl. 124/16; 29/428; 124/27

(57) ABSTRACT

Methods and apparatus for firing a projectile according to various aspects of the present invention comprise a stock capable of holding a projectile, a spring attached to the stock such that stored elastic energy is used to impart a propulsive force to the projectile. The spring may also engage a retention device configured to hold the spring in a predetermined position thereby allowing elastic energy to be stored in the spring until the user desires to fire the projectile by disengaging the retention device.

### CROSS-REFERENCE TO RELATED APPLICATIONS

This application claims the benefit of U.S. Provisional Patent Application No. 61/089,693, filed on Aug. 18, 2008, and incorporates the disclosure of the application by reference.

### BACKGROUND OF INVENTION

The field of archery has two classic ways of launching projectiles. The first is the bow and the second is the crossbow. In general, each of these methods utilizes a string or cord affixed on each end to a rigid or semi-rigid limb. When the string is drawn away from the rigid limb, elastic energy becomes stored in the limb and when the string is released that energy is converted into a launching force imparted to a projectile such as an arrow.

Despite the long history of the bow and crossbow, the basic design of each remains relatively unchanged. A common point of failure for each is the string or cord. Over time, the string may stretch out resulting in less stored energy in the limb. The string may also break during use and either result in injury to the operator, an unintended firing of the projectile, or the bow may become inoperable.

### SUMMARY OF THE INVENTION

Methods and apparatus for firing a projectile according to various aspects of the present invention comprise a stock capable of holding a projectile, a spring attached to the stock such that stored elastic energy is used to impart a propulsive force to the projectile. The spring may also engage a retention device configured to hold the spring in a predetermined position thereby allowing elastic energy to be stored in the spring until a user desires to fire the projectile by disengaging the retention device.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a projectile firing device showing a spring in an uncompressed position in accordance with an exemplary embodiment of the present invention;

FIG. 2 representatively illustrates the projectile firing device showing the spring in a compressed position;

FIG. 3 representatively illustrates a spring guide positioned along a stock of the projectile firing device; and

FIG. 4 representatively illustrates a top view of the projectile firing device showing multiple springs in accordance with an exemplary embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present specification and accompanying drawings show an exemplary embodiment by way of illustration and best mode. While this exemplary embodiment is described, other embodiments may be realized, and changes may be made without departing from the spirit and scope of the invention. The detailed description is presented for purposes of illustration only and not of limitation. For example, the steps recited in any of the methods may be executed in any suitable order and are not limited to the order presented. Further, conventional mechanical aspects and elements of the individual operating components of the system may not be described in detail. The representations of the various components are intended to represent exemplary functional relationships, positional relationships, and/or physical couplings between the various elements. Many alternative or additional functional relationships, physical relationships, optical relationships, or physical connections may be present in a practical system.

The present invention may be described herein in terms of functional components and various methods. Such functional components may be realized by any number of components configured to perform the specified functions and achieve the various results. For example, the present invention may employ various materials, projectiles, body shapes, sizes and weights for various components e.g., stock bodies, frames, springs, mechanical components, and the like, which may carry out a variety of functions. In addition, the present invention may be practiced in conjunction with any number of archery or projectile launching applications, and the system described is merely one exemplary application for the invention. Further, the present invention may employ any number of conventional techniques for projectile launching, and the like.

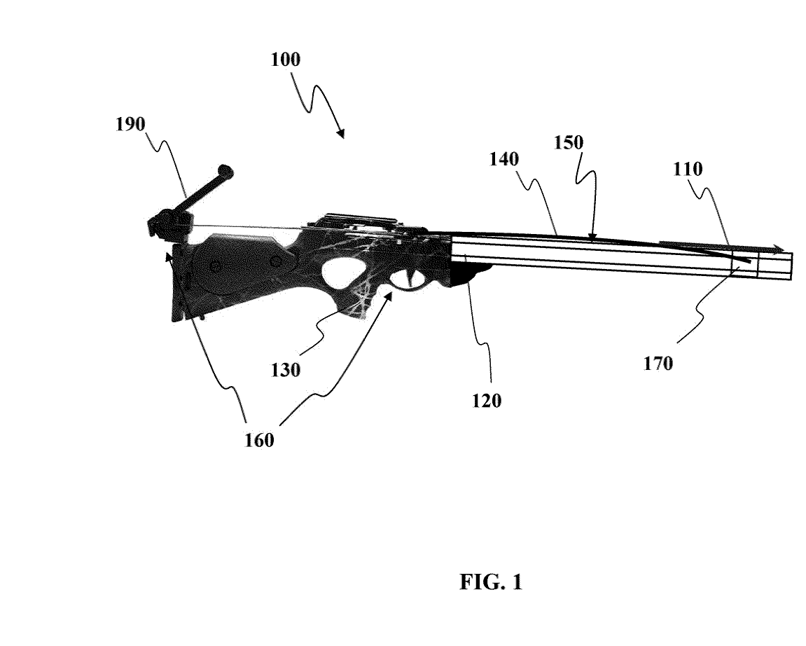

Various representative implementations of the present invention may be applied to any system for launching projectiles. Certain representative implementations may include, for example, stringless bows, crossbows, ball launchers, and/or the like. Referring to FIG. 1, methods and apparatus for a projectile firing system 100 according to various aspects of the present invention may operate in conjunction with a projectile 110, a stock 120, a grip assembly 130, and a spring 140.

The projectile 110 may comprise any object that is configured to be fired or launched. In the present embodiment, the projectile 110 comprises a bolt, such as that used in a typical crossbow. In another embodiment, the projectile 110 may comprise an arrow, a ball, a skeet, a pellet, or other ballistically fired object.

The stock 120 supports the projectile 110 prior to firing and may be used, at least in part, to allow a user to aim and fire the projectile 110. The stock 120 may comprise any system for securing and/or holding the projectile 110 and selectively firing it, such as a rifle stock, a crossbow stock, a tube, a truss-like body, and the like. The stock 120 may comprise any suitable material such as wood, metal, plastic, or composite material such as carbon reinforced graphite or fiberglass. For example, referring to FIG. 1 in the present embodiment, the stock 120 may comprise a long narrow frame similar to a typical rifle and may further comprise a projectile channel 150, a retention system 160, and a spring guide 170.

One end of the stock 120 may further be configured to be placed on the ground or braced against a similarly rigid object in order to facilitate the use of the retention system 160, such as when placing the spring 140 into a loaded position. For example, the forward end of the stock 120 may be configured with a foot brace (not shown) that is pressed against the ground in order to counter the forces associated with compressing the spring 140 towards the rear portion of the stock 120. The stock 120 may also comprise fixed or pivotal attachments to facilitate use of the retention system 160.

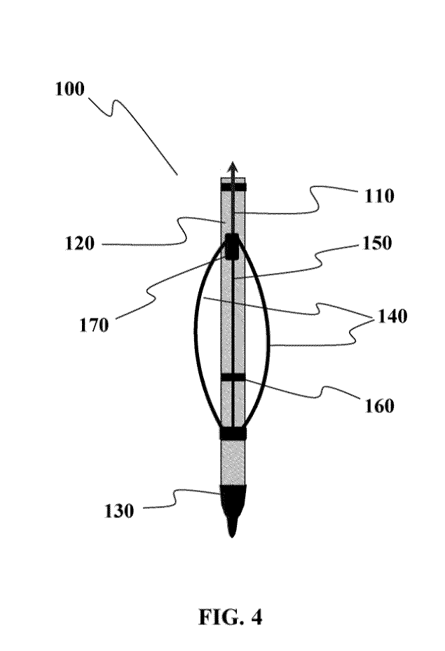

The projectile channel 150 may guide the movement of the projectile 110 when fired. The projectile channel 150 may comprise any suitable system for directing the projectile 110 motion when fired, such as a recessed channel, a tube, or a hollow bore in the stock 120. Referring to FIGS. 1 and 4, the projectile channel 150 comprises a linear recessed channel along the upper surface of the stock 120. The projectile channel 150 may also be configured to align with the stock 120 such that the projectile 110 is fired in the direction that the stock 120 is pointed.

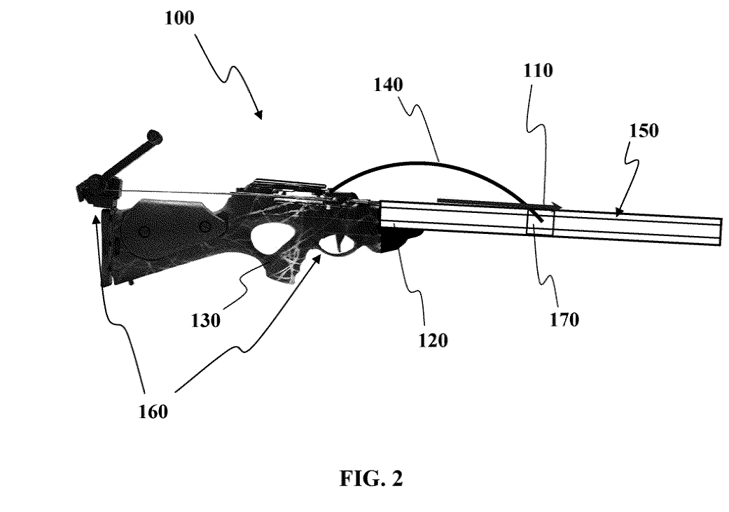

The retention system 160 allows the spring 140 to be selectively held in a loaded, or compressed position. The retention system 160 may comprise any system for moving the spring 140 from an unloaded position to a loaded position, such as a crank, a pushrod, a pull handle, or a receptacle for a removable tool. The retention system 160 may also be connected to one end of the spring 140 allowing the operator to load the spring 140 locking it to a retainer. Referring to FIGS. 1 and 2, in one embodiment the retention system 160 may comprise a crank 190 affixed to the stock 120. The crank 190 may engage the spring 140 and be configured to compress the spring 140 in a ratcheting manner. For example, a cable may be coupled between the crank 190 and the spring 140. As the crank 190 is turned the cable may draw one end of the spring 140 towards the other end of the spring 140 in either a smooth or stepped manner.

The crank 190 may also be configured for manual operation or automated by the use of an electric motor. For example, an electric motor may be positioned within a rear section of the stock 120 and/or grip assembly 130 and be suitably connected to the spring 140 such that the motor compresses the spring 140.

Alternatively, the retention system 160 may comprise a handle affixed to one end of the spring 140. The handle may fold out perpendicular to the surface of the stock 120 allowing the operator to apply a force to the handle and subsequently move the spring 140. For example, a set of foot plates may be placed at the forward end of the stock 120 and be configured to rest against the ground while the operator steps on the foot plates. Then with the projectile firing system 100 braced, a handle connected to the spring guide 170 may be pulled in the opposite direction of the foot plates thereby moving the spring 140 to a compressed position.

In yet another embodiment, a removable tool may be connected to the spring 140 to facilitate manual compression of the string 140. For example, the operator may brace one end of the stock 120 against the ground and then secure the removable tool to the spring 140 in a manner that either provides increased leverage for moving the spring 140 or provides a handle sufficient to allow the operator to compressively load the spring 140.

The retention system 160 may also be configured to compress the spring 140 to one or more positions thereby providing for a selectively adjustable projectile launching force. For example, in one embodiment, the ratcheting action of the crank 190 may serve to secure the spring 140 to the retainer at various levels of compression. In another embodiment, the retention system 160 may have one or more intermediate steps between a fully compressed position and a fully decompressed position for the spring 140. For example, the retention system may be suitably configured to secure the spring 140 at predetermined steps of about a ten percent difference in compression from between fifty percent total compression and 100 percent total compression.

The retainer may hold the spring 140 in the compressed position after the retention system 160 has been used to reposition the one end of the spring 140. The retainer may comprise any system for holding the spring in a compressed state such as a latch, a tab, a clasp, a lock, or the like. In the present embodiment, a mechanical lock engages the slideably attached end of the spring 140 when it is in a loaded position and holds the spring 140 in that state.

A trigger coupled to the retainer may act as the fire initiation mechanism of the projectile firing system 100 unlocking the spring 140 from the compressed state. The trigger may comprise any system for releasing the spring 140 from a loaded position, such as a latch or a lock. For example, in the present embodiment, the trigger may comprise a finger activated lever positioned within the grip assembly 130 and coupled to the retainer. The trigger may be responsive to an applied pressure resulting in a release of the retainer allowing the stored energy in the spring 140 to propel the slideably attached end of the spring 140 rapidly towards the forward end of the stock and an uncompressed position. The trigger may, however, be configured in any suitable manner that allows for the retention and subsequent release of the spring 140 from a loaded state. In another embodiment, the trigger may comprise a thumb activated button or a tab positioned along a surface of the stock and/or grip assembly 130.

The trigger may also comprise a safety feature to prevent accidental firing of the firing system 100. The safety feature may prevent movement of the trigger or decouple the trigger from the retainer thus allowing the trigger to move without affecting the retainer.

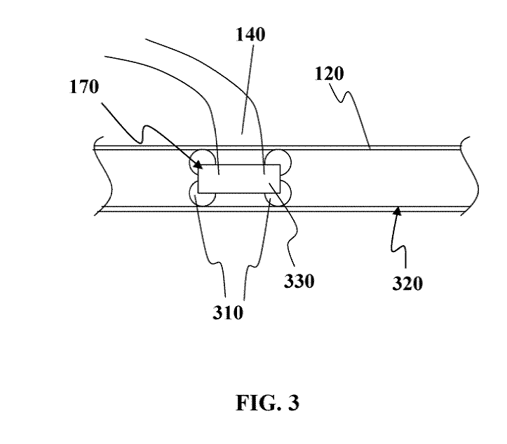

The spring guide 170 may facilitate movement of the slideably attached end of the spring 140 along the stock 120. The spring guide 170 may comprise any system for guiding the translating motion of the slideably attached end of the spring 140 along the stock 120 such as a roller, a channel, or a moveable piston. For example, referring to FIG. 3 of the present embodiment, the slideably attached end of the spring 140 may coupled to a slider box 330 and translate along the stock 120 by a set of rollers 310 configured to roll along a roller track 320 disposed along a length of the stock 120. In another embodiment, the spring guide 170 may comprise a piston assembly configured to translate along the length of the stock 120.

The slider box 330 may connect to the slideably attached end of the spring 140 and may facilitate movement of the spring 140 along the spring guide 170. The slider box 330 may comprise any system for connecting the spring 140 to the spring guide 170 such as a box with a pivotal attachment for the slideably attached end of the spring 140 and at least two rollers 310 configured to roll along the roller track 320.

The roller track 320 may retain and guide the movement of the slider box 330 along the stock 120. The roller track 320 may comprise any system for directing the motion of the slider box 330 as the spring 140 is compressed and uncompressed. The roller track 320 may be positioned along one or more surfaces of the stock 120 or placed along the interior of the stock 120. Referring to FIG. 3 of the present embodiment, the roller track 320 may comprise an upper channel and a lower channel configured to allow the rollers 310 to move fore and aft as the spring 140 is compressed or uncompressed.

The rollers 310 allow the slider box 330 to move as the spring 140 moves from a compressed state to an uncompressed state. The rollers 310 may comprise any system for moving the slider box 330 along the stock 120 such as wheels, ball bearings, castors, and the like. In the present embodiment, the rollers 310 comprise low friction wheels attached to the slider box 330 at multiple locations. In another embodiment, the rollers 310 may comprise a series of ball bearings secured to the upper and lower channels of the roller track 320 that allow the slider box 330 to slide in between the ball bearings.

The grip assembly 130 may be positioned at or near one end of the stock 120 and allow the operator to disengage the retention system 160 and fire the projectile 110. The grip assembly 130 may also perform any additional function suitable for the projectile firing system 100 such as providing a method to hold and aim the projectile firing system 100 prior to firing the projectile 110. The grip assembly 130 may also be configured to provide a support or brace for the projectile firing system 100 during firing in order to increase the accuracy of the fired projectile 110.

The grip assembly 130 may also comprise any system that allows the retention system 160 to be disengaged by the operator. In the present embodiment, the grip assembly 130 is configured to allow the operator to partially support the weight of the projectile firing system 100 with one hand while allowing the index finger of the same hand to disengage the retention system 160 such as via the trigger 180. Alternatively, the grip assembly 130 may be configured to allow the retention system 160 to be disengaged by the thumb, multiple fingers, an increase in grip pressure, or any other suitable method.

The grip assembly 130 can be made of any suitable material such as plastic, metal, composite, or ceramic. The grip assembly 130 may also be configured in any way to allow the operator to hold the projectile firing system 100 such as a design similar to that used in traditional rifles or crossbows.

The spring 140 provides the propulsive force to the projectile 110. The spring 140 may comprise any system for firing the projectile 110, such as a coil spring or a leaf spring. In the present embodiment, the spring 140 comprises a leaf spring with a first end attached proximate to a first end to the stock 120 and a second end slideably attached to the stock 120 between the first end of the stock 120 and a second end of the stock 120. When the second end of the spring 140 is moved towards the first end of the spring 140, the spring 140 is compressed to a loaded position wherein the propulsive energy of the projectile firing system 100 is then stored in the spring 140 as elastic energy.

The spring 140 may be attached to the stock 120 so that when it is in a loaded position the spring 140 is bowed in any direction. For example, in the present embodiment, the spring 140 may be connected to the stock in manner that provides for the spring 140 to bow in an upward manner when compressed relative to the stock 120. Alternatively, the spring 140 may be position so that it is bowed downward or to one side when compressed.

The spring 140 may comprise any material suitably adapted to the application such as metal or plastic. For example, in the present embodiment, the spring 140 comprises a composite of fiberglass/epoxy. The spring 140 may also be comprised of other composite materials such as graphite or carbon in additional to more traditional metals and alloys.

The spring 140 may further comprise a projectile receptacle suitably configured to engage the projectile prior to and during the firing sequence. The receptacle may comprise any suitable system such as a notch, a clip, or a conforming receiver suitable adapted to fit around a portion of the projectile. In one embodiment, the receptacle may comprise a recessed notch disposed in a surface of the second end of the spring suitably shaped to receive an end portion of the projectile. The receptacle may also be suitably configured to securely hold the projectile to the projectile firing system 100 prior to firing despite movement of the projectile firing system.

The projectile firing system 100 may also be configured with more than one spring 140. Referring to FIG. 4, an alternative embodiment may comprise the use of two springs 140 attached to the stock 120 on opposite sides. The use of more than one spring 140 may increase the propulsive force on the projectile 110 compared to a single spring 140 and serve to counteract any resulting torque on the stock 120 caused when a single spring 140 is released from its loaded state during firing.

In operation, a projectile 110 is fired at a target by the propulsive force exerted on the projectile 110 by the stored energy of the compressed spring 140. The projectile firing system 100 may fire the pro jectile 110 in any appropriate manner. In the present embodiment, the projectile firing system 100 is first placed in a loaded stated by using the retention system 160 to compress the spring 140 until it locks against the retainer. Once the spring 140 is locked in a loaded or compressed position, a projectile 110 is placed into the projectile channel 150.

The user may then hold the system in one hand by the grip assembly 130 and aim the projectile firing system 100 at the desired target. The projectile firing system 100 may be further supported by the use of the operator's other hand at a position further down the stock 120. The projectile 110 may then be fired at the target by activation of the trigger 180.

Once the trigger 180 has been activated, the spring 140 is released and the elastic energy stored in the spring 140 will cause the spring 140 to return to its normal state in a rapid manner. As the slideably attached end of the spring 140 translates along the stock 120, it will impart a propulsive force on the projectile 110 causing it to be fired away from the projectile firing system 100 at high velocity.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A projectile firing device, comprising:
a stock comprising an aft end and a forward end; and
a leaf spring comprising a first end and a second end, wherein:
the first end is attached proximate to the aft end of the stock; and
the second end is:
slideably attached to the stock between the first end of the leaf spring and the forward end of the stock; and
configured to translate along the stock between the forward end of the stock and the first end of the leaf spring.

2. A projectile firing device according claim 1, further comprising a retention system connected to the stock and engaging the leaf spring, wherein the retention system comprises:
a retainer configured to selectively engage the second end of the leaf spring to hold the leaf spring in a compressed position; and
a trigger coupled to the retainer, wherein the trigger is configured to disengage the retainer from the second end of the leaf spring

3. A projectile firing device according claim 2, wherein the retainer further comprises an intermediate locking mechanism configured to hold the leaf spring in a less than fully compressed position.

4. A projectile firing device according claim 1, wherein the first and second ends of the leaf spring are pivotally attached to the stock.

5. A projectile firing device according to claim 1, further comprising:
a spring guide connected to the stock, wherein the spring guide defines a path along the stock in which the second end of the leaf spring translates; and
a slider box connecting the second end of the leaf spring to the spring guide, wherein the slider box is configured to translate along the path defined by the spring guide.

6. A projectile firing device according to claim 5, wherein the slider box comprises a set of rollers configured to move along the spring guide.

7. A projectile firing device according to claim 5, wherein the slider box comprises a piston assembly disposed along the length of the spring guide.

8. A projectile firing device according to claim 1, further comprising:
a guide channel disposed along a forward portion of the stock, wherein the guide channel is configured to receive the projectile; and
a receptacle engaging the second end of the leaf spring, wherein the receptacle is configured to secure the projectile to the second end of the leaf spring.

9. A projectile firing device according to claim 1, wherein the leaf spring comprises a composite material.

10. A projectile launching device comprising:
a stock, comprising a first stock end and a second stock end;
a grip connected to the first stock end;
a leaf spring comprising a first spring end and a second spring end, wherein:
the first spring end is attached proximate to the first stock end; and
the second spring end is:
slideably attached to the stock between the first spring end and the second stock end; and
configured to translate along the stock between the second stock end and the first spring end the leaf spring; and
a retention system connected to the stock and engaging the second spring end, wherein the retention system is configured to:
reposition the leaf spring from an uncompressed state to a compressed position;
retain the second spring end in the compressed position, and
selectively release the second spring end from the compressed position.

11. A projectile launching device according claim 10, wherein the retention system comprises:
a loading device engaging the second spring end, wherein the loading device is configured to move the second spring end from the uncompressed position to the compressed position;
a retainer coupled to the stock and configured to selectively engage and hold the second spring end in the compressed position; and
a trigger coupled to the retainer, wherein the trigger is configured to disengage the retainer from the second spring end.

12. A projectile launching device according claim 11, wherein the retainer further comprises an intermediate locking mechanism configured to hold the leaf spring in a less than fully compressed position.

13. A projectile launching device according to claim 10, wherein the leaf spring comprises a composite material.

14. A projectile launching device according to claim 10, further comprising:
a spring guide connected to the stock, wherein the guide channel defines a path between the second stock end and the first spring end in which the second spring end translates; and
a slider box connecting the second spring end to the spring guide, wherein the slider box is configured to translate along the path defined by the spring guide.

15. A projectile launching device according to claim 14, wherein the slider box comprises a set of rollers configured to move along the spring guide.

16. A projectile launching device according to claim 14, wherein the slider box comprises a piston assembly disposed along the length of the spring guide.

17. A projectile launching device according to claim 10, further comprising:
a guide channel disposed along a forward portion of the stock, wherein the guide channel is configured to receive the projectile; and
a receptacle engaging the second spring end, wherein the receptacle is configured to secure the projectile to the second spring end.

18. A method of manufacturing a projectile launching device, comprising:
providing a stock with a first stock end and a second stock end;
mounting a leaf spring comprising a first spring end and a second spring end to the stock, wherein:
the first spring end is attached proximate to the first stock end; and
the second spring end is slideably attached to the stock, wherein the second spring end is configured to translate between the second stock end and the first spring end, and
coupling a retainer to the stock, wherein the retainer is configured to selectively hold the second spring end in a compressed position;

19. A method of manufacturing a projectile launching device according to claim 18, further comprising connecting a slider box to the second spring end, wherein the slider box is configured to translate along a spring guide connected to the stock defining a path along the stock in which the second spring end translates.

20. A method of manufacturing a projectile launching device according to claim 18, further comprising connecting a loading device to the leaf spring, wherein the loading device is configured to move the second spring end from an uncompressed position to a compressed position.
